(19) United States
(12) Patent Application Publication
(10) Pub. No.: US 2018/0221115 A1
(43) Pub. Date: Aug. 9, 2018

(54) INTRA-BONE SECTION OF AN IMPLANT FOR DENTAL PROSTHESES

(71) Applicant: Vincenzo CRUDO, Montecchio Maggiore (IT)

(72) Inventor: Vincenzo CRUDO, Montecchio Maggiore (IT)

(21) Appl. No.: 15/886,149

(22) Filed: Feb. 1, 2018

(30) Foreign Application Priority Data
Feb. 3, 2017 (IT) 102017000011793

(51) Int. Cl. A61C 8/00

(52) U.S. Cl. CPC A61C 8/0028; A61C 8/0083

(57) ABSTRACT

An intra-bone section of an implant for dental prostheses, to be fixed within the bony part of the gingiva and adapted to receive, upon assembly, a tooth-anchoring superstructure.

The present invention relates to an intra-bone section of an implant for dental prostheses.

Nowadays the use is widespread of implants for fixing dental prostheses, which are constituted substantially by an intra-bone section with external threading and hollow in shape, to be fixed within the bony part of the gingiva and to which is fixed an anchoring superstructure for a dental prosthesis.

The superstructure is constituted by a stump for supporting an artificial tooth, which has an axial hole and is provided with a lower shank for coupling in a seat provided in the intra-bone section and is adapted to provide the support around which the tooth is built.

The superstructure usually also comprises a stump fixing pin which is inserted axially into the stump and is provided with a threaded portion which is associated, upon assembly, with a threaded dead hole which is provided axially on the bottom of the seat of the intra-bone section.

Typically the intra-bone section has a seat with a polygonal profile and the coupling occurs with a complementarily-shaped shank defined in the stump proper.

As is known, a tooth during mastication is subjected to great mechanical stresses that require stable immobilization and the complete absence of relative rotations between the dental prosthesis and the gingiva, and polygonal couplings do not guarantee a perfect stability of the tooth.

To this end an implant has been devised which is described in Italian patent no. 1288004. In the solution described, the seat of the intra-bone section has a portion that is substantially triangular in cross-section with rounded vertices and is coupled, upon assembly, with a complementarily-shaped portion of a shank defined in the stump. The remaining parts of the seat and shank are also complementarily-shaped and hexagonal in cross-section.

Although it ensures a stable coupling between the intra-bone section and the superstructure and without the risk of relative axial rotations between the two, it should be noted that the hexagon-to-hexagon coupling combined with the triangle-to-triangle coupling, the rounded vertices of which correspond to three alternating sides of the corresponding hexagons, determines a 50% possibility of error in the mutual positioning of the two components, a situation that can entail inconvenience for the patient.

With the aim of resolving such drawback, an implant for fixing dental prostheses has been improved and is described in U.S. Pat. No. 6,659,770 B2.

In such implant, the seat of the intra-bone section has a portion that is triangular in cross-section with rounded vertices and is coupled, upon assembly, with a complementarily-shaped portion of a shank defined in the stump element. The remaining parts of the seat and shank are below the portions with triangular cross-section, and are also complementarily-shaped, but are circular in cross-section.

The intra-bone section has, at the end that is directed toward the outside of the gingiva, a flared transgingival collar at which the seat, which has a portion that is internally conical, is axially defined.

By virtue of the portions with a circular cross-section, the proposed solution makes it possible to avoid errors in the coupling between the intra-bone section and the superstructure.

Furthermore, the flared transgingival collar facilitates the centering of the stump during its insertion into the intra-bone section.

Such solution is however susceptible of improvement because the intra-bone section has a shape structure that limits its use to implants that comprise a complementarily-shaped stump element with a portion that is circular in cross-section below the portion with a triangular cross-section.

The aim of the present invention is to provide an intra-bone section which is capable of improving the known art in one or more of the above mentioned aspects.

Within this aim, an object of the invention is to provide an intra-bone section that is capable of ensuring, in its coupling with a superstructure for an artificial tooth, a stable coupling with a stump element and without mutual accidental rotation between the two components, which facilitates the insertion of the stump element, and which is at the same time compatible with most of the stump elements present on the market nowadays.

Furthermore, another object of the present invention is to overcome the drawbacks of the known art in a different manner to any existing solutions.

A still further object of the invention is to provide an intra-bone section that is highly reliable, easy to implement and low cost.

This aim and these and other objects which will become better apparent hereinafter are achieved by an intra-bone section according to claim 1, optionally provided with one or more of the characteristics of the dependent claims.

Further characteristics and advantages of the invention will become better apparent from the detailed description that follows of a preferred, but not exclusive, embodiment of the intra-bone section according to the invention, which is illustrated for the purposes of non-limiting example in the accompanying drawings wherein:

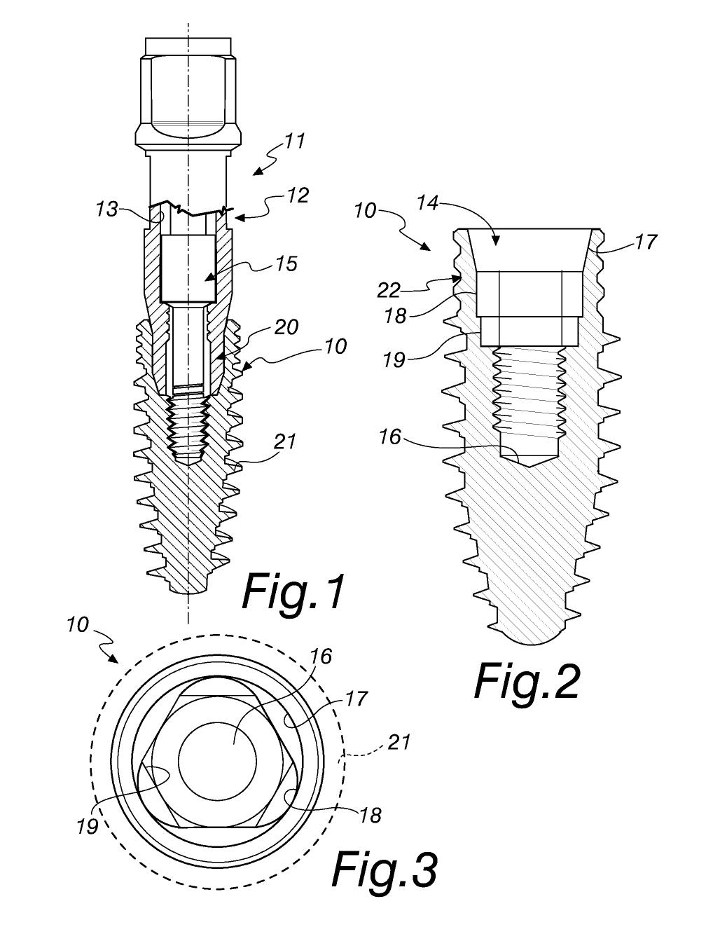

FIG. 1 shows an implant for fixing dental prostheses, with an intra-bone section according to the invention;

FIG. 2 is a cross-sectional side view of an intra-bone section according to the invention;

FIG. 3 is a view from above of the intra-bone section.

With reference to the figures, the intra-bone section according to the invention, generally designated by the reference numeral 10, can be utilized in the provision of an implant for dental prostheses.

The intra-bone section 10 is in fact to be fixed within the bony part of the gingiva and is adapted to receive, upon assembly, a tooth-anchoring superstructure, generally designated with the reference numeral 11.

The superstructure 11 serves to anchor the dental prosthesis, not shown, and is constituted by:

a stump 12 which has an axial through hole 13 and is to be accommodated partly in a seat 14 provided in the intra-bone section 10,

a stump fixing pin 15, to be inserted axially into the stump 12 and provided with a threaded portion which is associated upon assembly with a complementarily-threaded dead hole 16 which is provided axially on the bottom of the seat 14.

FIG. 1 shows an implant with an intra-bone section 10 and the superstructure 11. Therefore the stump 12 and the stump fixing pin 15 are also indicated. The whole is partially cross-sectional to show the coupling of the superstructure 11 with the intra-bone section 10 according to the invention.

As shown in FIG. 2, the seat 14 has, in cross-section, in the region for accommodating the stump 12 and in sequence from the top, a conical portion 17, a triangular portion 18 and a hexagonal portion 19.

The dead hole 16 is provided below the hexagonal portion 19, in order to receive, upon assembly, the threaded portion of a stump fixing pin 15.

The triangular portion 18 has rounded vertices, as can clearly be seen in the view from above in FIG. 3.

Also in that figure it can be seen that the vertices of the triangular portion 18 are provided on alternating sides of the hexagon shape of the hexagonal portion 19.

In FIG. 1 it is clear that the coupling between the intra-bone section 10 and a stump 12 occurs at a shank 20 of that stump 12, which must be at least partially shaped complementarily to the seat 14 of the intra-bone section 10 so that mutual rotation will not occur.

The external surface of the intra-bone section is contoured so as to define a threading 21 which is adapted to provide a self-tapping implant in the gingiva.

The intra-bone section 10 has, at the end that is directed toward the outside of the gingiva, a transgingival collar 22 at which the seat 14 is axially defined.

The wall of an end portion of the transgingival collar 22 has a conical shape that defines the conical portion 17, for guiding and self-centering the insertion of a stump 12, upon assembly.

Use of the intra-bone section, according to the invention, is evident from the foregoing description and explanation.

In particular, it is clear that the portions, triangular 18 and hexagonal 19 in cross-section, enable a coupling of a superstructure 11 with the intra-bone section 10 without the risk of relative rotations and it is also clear that the combined presence of such portions enable the use of the intra-bone section with stumps that have a shank end that is triangular in cross-section or hexagonal in cross-section or with both.

Substantially, the intra-bone section according to the invention can be adapted to numerous types of stumps present on the market.

Furthermore, the intra-bone section according to the invention is capable of facilitating the assembly of the implants because the conical portion of the seat facilitates the insertion and the centering of the stump.

In practice it has been found that the invention fully achieves the intended aim and objects by providing an intra-bone section that is capable of ensuring an easy and stable coupling with a stump element and without accidental mutual rotation, compatible with most of the stump elements present on the market nowadays.

The invention, thus conceived, is susceptible of numerous modifications and variations, all of which are within the scope of the appended claims. Moreover, all the details may be substituted by other, technically equivalent elements.

In practice the materials employed, provided they are compatible with the specific use, and the contingent dimensions and shapes, may be any according to requirements and to the state of the art.

The disclosures in Italian Patent Application No. 102017000011793 (UA2017A000674) from which this application claims priority are incorporated herein by reference.

What is claimed is:

1. An intra-bone section of an implant for dental prostheses, to be fixed within the bony part of the gingiva and adapted to receive, upon assembly, a tooth-anchoring superstructure which is constituted by:
a stump which has an axial through hole and is to be accommodated partly in a seat provided in said intra-bone section,
a stump fixing pin, to be inserted axially into said stump and provided with a threaded portion which is associated upon assembly with a complementarily-threaded dead hole which is provided axially on the bottom of said seat,
wherein said seat has, in cross-section, in the region for accommodating said stump and in sequence from the top, a conical portion, a triangular portion and a hexagonal portion.

2. The intra-bone section according to claim 1, wherein such triangular portion has rounded vertices.

3. The intra-bone section according to claim 1, wherein an external surface thereof is contoured so as to define a threading which is adapted to provide a self-tapping implant in the gingiva.

4. The intra-bone section according to claim 1, having at an end that is adapted to be directed toward the outside of the gingiva, a transgingival collar at which said seat is axially defined.

5. The intra-bone section according to claim 4, wherein a wall of an end portion of said transgingival collar has a conical shape that defines said conical portion, for guiding and self-centering the insertion of a said stump, upon assembly.
